(19) United States
(12) Patent Application Publication
(10) Pub. No.: US 2008/0066638 A1
(43) Pub. Date: Mar. 20, 2008

(54) Security Sheet Checking Apparatus and Corresponding Control Method of a Printing Machine

(75) Inventors: Roberto Salgari, Basiglio (IT); Maurizio Ripamonti, Segrate (IT)

Correspondence Address: YOUNG & THOMPSON, 745 SOUTH 23RD STREET, 2ND FLOOR, ARLINGTON, VA, 22202, US

(73) Assignees: OFFICINA RIPARAZIONI MACCHINE GRAFICHE - O.R.M.A.G. - S.P.A., NOVEGRO DI SEGRATE (MILANO) (IT); PARVIS SYSTEMS AND SERVICES S.R.L., MILANO (IT)

(21) Appl. No.: 11/597,475

(22) PCT Filed: May 26, 2005
(86) PCT No.: PCT/IB05/51726

§ 371 Date: Nov. 22, 2006

(30) Foreign Application Priority Data
May 26, 2004 (IT) MI2004A001054

(51) Int. Cl. B41F 1/54; B41F 33/00

(52) U.S. Cl. 101/484; 101/91

(57) ABSTRACT

A method and a security sheet inspection apparatus is described of the type includes at least a main driving cylinder (3), whereto a security sheet to be inspected is made to adhere, as well as an inspection system including at least an illuminator (5), a camera (6) for sheet image acquisition and a processing unit of the image to check sheet print quality, wherein there is further provided a sheet-feeder (2) feeding sheets from a tray (1) above the main cylinder (3) and a pair of secondary cylinders (8′, 8″), mutually adjacent and adjacent to the main cylinder (3), to draw each security sheet from the main cylinder, to upturn it and present it again turned face down on the main cylinder (3), the three cylinders being apt to rotate and being controllable independently from one another, the cylinders and the inspection system being housed in a self-enclosed unit.

### FIELD OF THE INVENTION

The present invention relates to a security sheet checking apparatus, in particular to an apparatus apt to operate in conjunction with a printing machine, and to a control method of a printing process.

### BACKGROUND ART

As known, the printing of security sheets, in particular of banknote sheets, is becoming an ever more complex process.

The quality level of circulating banknotes, in fact, is justified not only by aesthetic accuracy, but there are objective requirements to be met which allow smooth handling of the banknotes, in particular by the automatic machines which are to check for the genuineness thereof and to authorise currency transactions.

Moreover, the security features found on banknotes are increasingly more sophisticated, to prevent counterfeiting, which is becoming increasingly more approachable with the growth in size of common markets, for example the Eurozone.

Therefore, the entire cash-handling cycle is increasingly based on automatic equipment requiring the presence of “machine-readable features”, which must be printed with high quality standards and absolutely consistent with specific standard definitions.

In the past, banknote quality output from the printing process was guaranteed by visual inspection carried out by expert operators, which provided a result affected by a certain degree of subjectivity and low repeatability. Even today, in many countries, a certain amount of manual control is performed.

Further specific measuring tools exist, arranged to the side of the printing machine, which serve to carry out specific measurements on sheets manually removed from the printing system by an operator. This occasional operation is performed on the operator's initiative, whenever he needs to check certain individual printing parameters and it is hence not automatic and does not allow to implement an industrial checking and control system.

In other cases, automatic systems are used, integrated in the printing machine, for checking 100% of the banknotes delivered by the system. With this type of in-line apparatuses, security sheets are examined one by one and those considered defective according to specific pre-established parameters are rejected and discarded.

However, this approach caused disadvantages. As a matter of fact, such apparatuses work with low precision and resolution and, due to speed system and to the difficult environmental conditions (vibrations), they do not have automatic calibrations and control 100% of production (which makes them costly in terms of workload).

Moreover, the setting in of high quality standards, obtained by employing fully automatic final inspection systems, has caused the percentage of rejected product to increase significantly. This has further evidenced the need to act upstream, on the printing process, detecting and checking process creeps and drifts which lead to waste production.

Therefore, the attention of security sheet printers today has shifted from solutions acting on downstream control, with possible discarding of the defective product, to solutions controlling and optimising the production process.

Starting from this requirement, the Applicants have identified that the inspection techniques employed so far, both the manual one and the in-line one, were unsuitable and that a new, much more effective way could be identified, apt to supply the information required and sufficient to act promptly on the printing process, but without a redundant and economically inefficient workload.

### SUMMARY OF THE INVENTION

As a result, the object of the present invention is to provide an inspection apparatus—and an operational method thereof—apt to work in combination with a security sheet printing machine, which supplies effective information to act promptly on the printing process, but which at the same time is self-contained, inexpensive and of a limited bulk.

Such object is achieved by an apparatus and a method as described in its essential features in the accompanying main claims.

According to a first aspect, the apparatus according to the invention comprises a system for the transfer and quality inspection of sheets printed by sheet printing systems, in particular in the industry of “security printing” (such as banknote sheets), configured in such a way as to be extremely compact and self-contained, and which can hence be placed both beside the printing apparatus, and in correspondence of an output pile of the same. Quality control is performed automatically by a wide range of measurements performed on sheets removed by the production line and introduced in the apparatus of the invention by programmed or controlled sampling. Analysis of the data obtained from the measurements, as well as presentation of such results, are performed by specific software routines. The control automatically performed with high precision by the apparatus supplies the machine operators with useful indications for the optimisation of the printing process in progress.

According to another aspect of the invention, an electro-mechanical and pneumatic system is provided which draws a sample sheet, among the ones placed in an input storage, and places it on a first presentation drum presenting it to an image acquisition device. First a face of the sheet is acquired and then the transparency image, by scanning a second time. The system further provides a second pair of cylinders apt to turn the sheet to present it again to the first drum and acquire the other face thereof. These three fundamental images, front, back and transparency, acquired with a high resolution (300 dpi or greater), allow a detailed analysis of what has been printed. Further images can be acquired through special lighting systems, for example UV, or through other types of detecting sensors, such as magnetic sensors capable of detecting inks or other magnetic elements, such as the security threads included in the substrate.

According to a further aspect, the apparatus of the invention comprises a motorised rail which allows to move and position other types of sensors required to check for specific security features. Among the sensors which can be mounted on this bar the following can be mentioned: a matrix videocamera, for the acquisition of images of limited areas (about 10×10 mm) with a high resolution (5, 10 micron/pixel), or sensors capable of detecting special security features included in the banknotes.

The resolution and the precision of the measurements carried out by the apparatus of the invention are extremely high and suitable to immediately detect a deviation or drift of the printing process, before it can degenerate to the point of delivering a product which has to be discarded at the final check. Through statistical analysis, the system makes useful information available to the operator, which information enables him to monitor the specific process and to always make it work within its optimal value range.

According to a further relevant aspect, in the apparatus of the invention calibration targets and automatic references are provided, which guarantee the necessary accuracy, repeatability and reliability of measurements, without the need for a prompt and specific intervention by the operator. Detailed reports issued by the apparatus further certify the quality of each manufactured batch.

According to a last aspect of the invention, a control method of a manufacturing line for security sheets is provided, wherein a handling and inspection apparatus automatically draws a sample security sheet from the printing line, inspects at a high resolution the significant features thereof and determines the acceptability thereof against predetermined parameters, supplying an indication of the current print quality level. Furthermore, the method provides to detect by statistical survey any inspectable security sheet parameters which deviate or exceed pre-established threshold values and hence to supply an intervention index, apt to enable the operator to adjust the printing machine in order to bring said inspectable parameters back within the pre-established ranges.

A method variant provides that the input to draw the sheet to be inspected be supplied to the inspecting apparatus by the printing machine, at certain predefined times or upon occurrence of specific conditions.

Other inventive aspects of the apparatus are described in the dependent claims.

### BRIEF DESCRIPTION OF THE DRAWINGS

Further features and advantages of the apparatus and method according to the invention will in any case be more evident from the following detailed description of a preferred embodiment of the same, given by way of example and illustrated in the accompanying drawings, wherein:

FIG. 1 is a diagrammatic side elevation view which shows a printing plant with the apparatus according to the invention arranged in a test outlet or in an output pile; and

FIG. 2 is a diagrammatic perspective view of the apparatus according to the invention.

### PREFERRED EMBODIMENTS OF THE INVENTION

The apparatus according to the invention is fully incorporated in a substantially parallelepipedal box or housing, in the upper part of which a storage tray 1 and a feeder 2 for the drawing of sheets are provided: within it there is instead the security sheet movement and inspection system.

The movement system comprises a first main cylinder 3, rotating about its longitudinal axis, and a pair of adjacent counter-revolving cylinders 8′ and 8″, all substantially mutually tangent. The three cylinders are each driven by an independent motor, apt to rotate them into pre-established positions or at a controlled speed in both directions.

Main cylinder 3 is hollow and entirely made of clear plastic material, for example polycarbonate. The security sheet, for example a banknote sheet, coming from the above-lying feeder 2, is made to adhere to the external surface of said cylinder to carry out inspection thereof.

The pair of cylinders 8′ and 8″ has the function of drawing the security sheet from the main cylinder, of turning it and of presenting it again upturned to the main cylinder. Another function of these cylinders consists in drawing the sheet from main cylinder 3 to convey it to an underlying output pile 10.

An exemplary movement sequence is the following: cylinder 3 brings the sheet in correspondence of cylinder 8′, with an anti-clockwise rotation (arrow F₁). In the position of relative tangency between the cylinders, the linear speed of the two is substantially the same as far as modulus and direction are concerned: in this position the security sheet is transferred from main cylinder 3 to the first secondary cylinder 8′. Cylinder 8′ picks the sheet up and brings it in correspondence of cylinder 8″ following a clockwise rotation (F₂). Cylinder 8″ picks the sheet up and brings it in correspondence of cylinder 3 following an anti-clockwise rotation (F₃). Cylinder 3, which in the meantime has inverted its direction of revolution taking up a clockwise rotation direction, picks the sheet up and draws it in front of the videocamera for inspection.

The sheet is held on the cylinders and released by the same using gripping bars and suction intakes.

In particular, the sheet is kept in position and transported by the cylinder through “air gripping”, obtained through a suction system which generates negative pressure on suitable rows of small holes. The sheet exchange, from one cylinder to the other, occurs by positioning the corresponding hole including areas in correspondence one of the other, and consequently generating negative pressure on the cylinder which is to pick the sheet up and positive pressure on the one which is to release it: in this way the sheet is moved away from the cylinder which previously held it back and it is transferred/sucked closer to the cylinder which is to accept it.

The use of this method, in conjunction with direct drive of the engines of each cylinder, allows all possible levels of freedom in moving the sheet.

The sheet can therefore be drawn from the input pile, be presented to the inspection system according to rotation in a certain direction or in the opposite one, be exchanged between the various cylinders and be dropped on the output pile. Air grippers do not have a preferred direction and, having no protrusion, they do not pose any constraint to the sheet movement system.

This arrangement, although extremely compact and stable (for example, with a main cylinder having a 400-mm diameter and the two secondary cylinders having a 200-mm diameter, it is possible to limit maximum bulk to a parallelepiped measuring about 750×1000×1000 mm), allows to drive the sheet first in one direction and then in the other, thereby exposing both surfaces, both front and back, to the various sensors of the inspection system.

Thanks to the main cylinder being clear, it is further possible to carry out a transparency inspection, according to the way described also in application PCT/IT02/594 which is hereby incorporated by reference.

The system comprises a first illuminator 4, for reflective inspection, and a second illuminator 5 found inside clear cylinder 3, for transparency inspection of the security sheet.

Preferably the first illuminator for reflective inspection radiates a light in the visible or UV range; the second illuminator for transparency inspection radiates a light in the near-IR range.

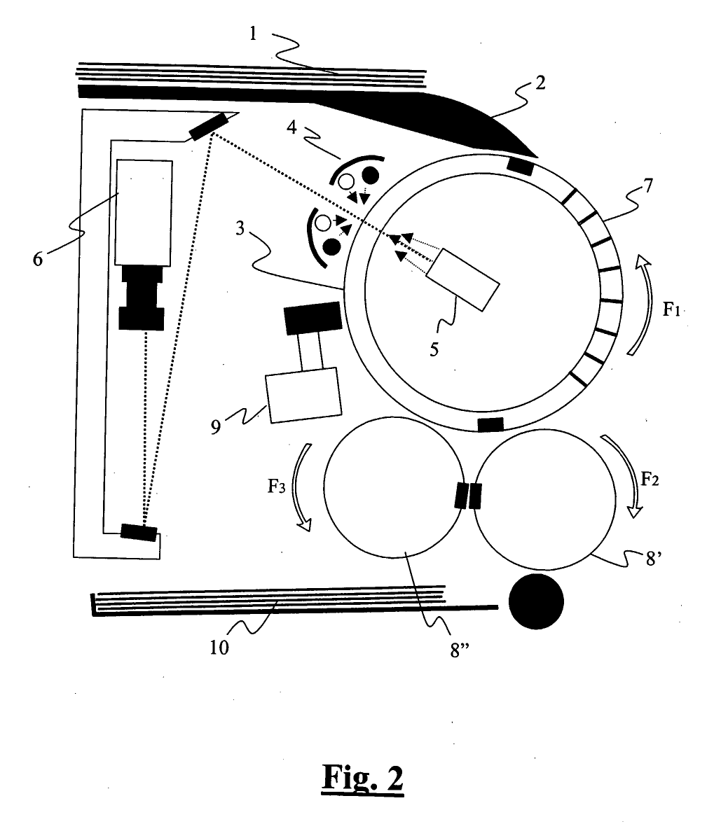

As shown in FIG. 2, the reflected or transparency image of the security sheet is acquired along an optical path—the length of which is reduced by means of lenses and mirrors—by an image acquisition system 6, for example a high-definition (300 dpi) linear sensor for reading the visible and infrared range, arranged in the left-hand part of the apparatus. The acquisition system preferably has an antidazzle system as illustrated in PCT/IT02/594.

According to a preferred embodiment, a series of fixed positioning and calibration references 7 are provided on main cylinder 3. For example, on the cylinder outer surface, in a position which can be framed by the desired sensors, a series of targets are mounted in the shape of bars containing calibration areas and patterns. Such patterns allow to check and calibrate the sensors before using said sensors for data detection, guaranteeing greater accuracy, reliability and repeatability of the measurements made.

Examples of calibration targets are: reference white areas, reference colours, references for optical distortion, fire reference, invar bar for checking resolution and correction of thermal expansions, and so on.

During use, the various bars are positioned opposite the sensors to be calibrated, in particular in the area framed by the videocamera, by driving the motor of the main cylinder which allows positioning at any angle and with maximum accuracy.

Thanks to these calibration targets, the apparatus of the invention can operate automatically and in a fully autonomous way, being able to calibrate the acquisition system whenever it is necessary and without it being required to temporarily introduce other devices.

The calibration procedure is extremely important to be able to obtain comparable and repeatable results and information, regardless of the current environmental and operative conditions, on the basis of which to establish whether the acquired image falls within the pre-established acceptance parameters.

If desired, other read sensors can also be provided, such as magnetic band sensors, magnetic ink sensors or sensors detecting special security features embedded in the banknotes.

Such sensors can be provided to be mounted on a motorised rail, integral with the main cylinder, which allows a sensor-mounting carriage to be displaced along the axis of the main cylinder. This movement, combined with cylinder revolution, allows to position the special sensors anywhere on the sheet for detection of a signal. The signal can be picked up both in static conditions and while moving along the cylinder axis, along any circumference or any trajectory. By the same mechanism it is possible to position the sensors on the respective calibration targets.

During operation, a group of 20-30 sheets (or a smaller number, as in the case in which the apparatus is integrated in the print line according to what will be illustrated in the following) is dropped on the storage tray 1, where feeding system 2 provides to feed the sheets one by one and to bring them in position to be gripped and driven into motion by main cylinder 3.

To allow the use of only one group of sensors, at the same time limiting system size and cost, sheet motion is performed by a single cylinder. Once completed the analysis of the front (first full revolution) and of the transparency image (second full revolution) on main cylinder 3, the sheet is turned by the two secondary cylinders 8′ e 8″, having a smaller size, and repositioned on the main cylinder for inspection of the other side.

The three cylinders are driven by independent motors (direct drive) which allow to directly control position, speed and movement direction.

Sheet presentation to the image acquisition system, and to any other sensors, occurs through the only inspection cylinder made of a clear material. Cylinder transparency provides an excellent background for image acquisition in a condition of reflected light, since a black background is obtained. The clear cylinder further allows to acquire images of sheets by transmitted light (transparency) using the illuminator located inside the cylinder.

As illustrated, a single videocamera 6 is used to acquire the front-back-transparency images. Transparency images are preferably acquired in the near-IR band (about 880 nm), whereas reflective ones are acquired in the bands of the visible RGB range. This is made possible also by optics which includes an IR-pass and an IR-cut filter exchange mechanism.

Using a single videocamera, as well as system cost reductions, allows to obtain front-back-transparency images which may be better compared to each other, since they have been acquired by the same optical assembly.

By way of example, the apparatus according to the invention can operate during the inspection step acquiring 600 Mb worth of data for each sheet, at a measuring rate of one sheet per minute. Preferably, the apparatus is equipped with a multiprocessor system to have a suitable processing capacity in all conditions.

In the logical unit of the apparatus (not shown), various measurements or numerical comparison between the acquired image and the preset tolerance profile are further made, according to techniques known per se which will not be described in further detail here.

The information supplied by the apparatus preferably provides SPC reports, which allow timely and effective detection of drifts and deviations of the printing process from standard reference values.

In addition to these reports, which are useful for controlling the printing process, the apparatus of the invention can supply information on quality measurements for certification of manufactured batches.

Interaction with the operator is preferably achieved through a user-friendly graphic interface as well as by implementing training and system setup procedures which are as intuitive and simple as possible.

In addition to being able to operate as a self-contained and independent working unit, as seen so far, the apparatus according to the invention can be advantageously suitably integrated with a full printing system.

In such case it is configured to be inserted in any output pile of the printing system or in the specific test outlet provided for sheet sampling.

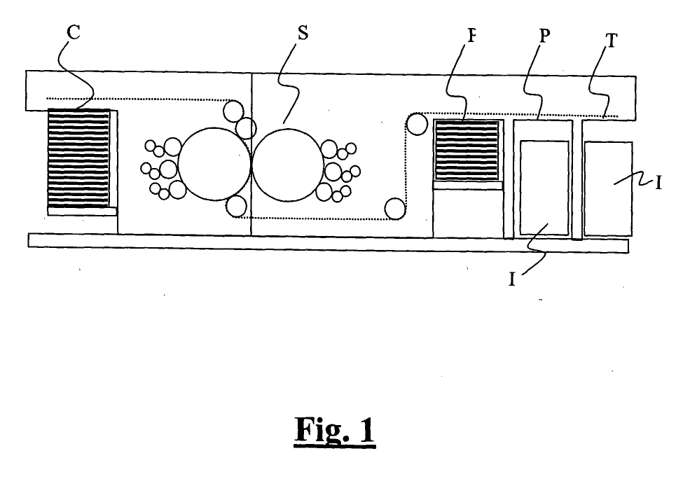

FIG. 1 shows an exemplary printing machine equipped, in a manner known per se, with a loading station C, with a proper printing station S, and with a series of pile outlets P—wherein the printed security sheets are automatically piled, before being removed—or with test outlets T—wherefrom some sheets can be picked up samplewise, imparting a suitable control to the printing machine.

According to a preferred variant, the invention provides that in one of the output piles of the printing machine there is inserted an inspection apparatus I, as described above, apt to perform a high-quality check on a security sheet or on a consecutive series of sheets, drawn samplewise from the printing machine.

The security sheet is drawn samplewise setting in the programme of the printing machine that said sheet be conveyed towards the outlet occupied by the inspection apparatus at pre-established time intervals.

According to another embodiment, the sample sheet is conveyed towards the outlet of the inspection apparatus upon the operator's control or when specific conditions occur, for example upon printing completion of the 10^{th}, 20^{th}, 21^{st} and 100^{th} sheet after restarting the printing machine.

According to a further preferred embodiment, the sample sheet is conveyed towards the outlet suitable for drawing by the inspection apparatus I upon control of the latter, according to pre-established criteria within the SPC system, for example when it is determined that a certain printing parameter, during the last inspection carried out, has exceeded a certain nominal threshold value.

The inspection apparatus, not working in-line, in any case at inspection rates which are certainly not the same as the output rates of the printing machine (as a matter of fact not 100% of the output sheets are inspected, but only some sample sheets), handles the security sheet at a reduced speed and can hence perform a series of high-definition detections and checks, as seen above.

High-definition inspection of the security sheet can immediately highlight small deviations of a series of printing parameters which, per se, fall within the acceptability limits pre-established in quality standards, but which are anyhow a sign of deviation in the printing process. Furthermore, suitable aggregations of the measurements made on the product delivered by the printing machine can allow to identify the system part requiring a check. This allows to automatically supply a significant piece of information to the operator, who can thereby intervene, manually or by agreeing to an automatic correction procedure, on the operation parameters of the printing machine, to bring them back to nominal values, before the deviation causes unacceptable defects in the security sheets, which would be irretrievably rejected by the final checking and sorting systems.

In this version, the apparatus is capable of performing all its functions in a fully automatic way. Said apparatus is further capable of varying the sampling frequency, according to current requirements, by directly communicating its requests for sheets to the printing system or plant.

In order to be able to transfer signals and controls between the inspection apparatus and the printing machine, communication lines of various types are provided, for example via cable or via radio. A suitable control software, preferably implemented in the control unit of the inspection apparatus, ensures that the two devices can communicate with each other in the appropriate way and using a single communication protocol.

As seen, hence, the apparatus of the invention can be made to operate in various modes:

1. “Stand alone” or independent, in case a series of sheets are manually transferred by the operator from the printing machine to the storage tray; this mode is useful to carry out in-depth checks on sample sheets of different batches chosen by the operator according to needs.

2. Inserted in the print line (FIG. 1): in this case the sheets are automatically transferred onto the storage tray directly from the print line, according to various criteria, and no human intervention is consequently required.

3. With feedback to the print line: the apparatus is integrated in the print line, as in the mode of the previous point, and statistical analysis carried out onboard the apparatus supplies data which is directly sent to the print line, in order to activate an automatic control and/or adjustment of the printing process.

As can be guessed, the apparatus according to the invention fully achieves the objects set forth in the preliminary remarks, as well as a series of remarkable advantages over the prior art.

As a matter of fact, the apparatus of the invention is extremely compact and is designed as a fully automatic and self-contained system, capable of making precision-measurements on a series of sheets of different batches or on samples of the produced sheets, controlling the process under way with SPC criteria. In the integrated version, the sheets are automatically transferred from the printing system to the measuring system upon request of the latter, therefore also intervention of an operator is no longer required.

Since the inspection system is included in this self-contained apparatus, it is possible to handle the sheet in the ideal modes to carry out the required measurements (ideal speed, minimum vibrations) allowing to obtain resolution and precision levels not achievable within a printing machine.

Since the apparatus is arranged substantially outside the printing machine, in addition to dramatic vibration reduction, it is also possible to prevent the system from experiencing dust problems which could affect accuracy and stability thereof.

Notwithstanding its valuable compactness, the apparatus of the invention offers a variety of sensors and of inspection modes, therefore it is not a tool for making a single measurement, but it is capable of performing a full set of measurements.

The capability of the apparatus of automatically performing the analysis of front, back, transparency and other, as well as the capability of self-calibrating itself, with no manual intervention, is to be considered as absolutely innovative and extremely advantageous for implementing the printing process control, over the existing known art systems.

Finally, thanks to the equipment of sensors and to the effective sheet moving system, the system is capable of performing all the following checks: front, back and transparency quality measurements of the banknote sheets; print quality check (geometric check, absolute and relative register check, colour check, check of narrow lines and micro-printings); substrate inspection (integrity check, check for colour evenness, check of watermarks of any type); inspection on the security features of the substrate (security threads 1D and 2D, OVD stripes, iridescent stripes); check of the relative position of the features (geometric check, front/back stagger, check of the position of MRF (Machine Readable Feature) against offset print or against the sheet edges, offset print against the features of the substrate); microlettering inspection; inspection of other banknote security features; check of magnetic security threads and of magnetic inks.

In one of its applications, the system of the invention is extremely effective when combined with printing machines which operate simultaneously on both sheet faces. In this case, the on-line control employing traditional techniques would require simultaneous use of two systems, with significant costs of the solution, as well as the other limitations. The devised system, given its capability of inspecting first one face and then the other face of the sheet, too, proves extremely advantageous for checking this specific printing process.

Thanks to the use of the apparatus of the invention integrated in the print system, the final waste fraction is reduced (virtually only sudden random defects remain, but not regular ones, which can generate waste), more stable and even printing is obtained, which determines optimal working conditions for the final sorting systems, printing machines are continuously kept in their ideal working conditions, best exploiting the features thereof, and the overall quality of production is improved.

It is to be appreciated that, in the condition of operation of the apparatus integrated with the printing machine, the winning factor lies indeed in the fact that the sheets are automatically conveyed from the print system to an optimal measurement environment (because it is not affected by working conditions and the vibrations of the print line): the solution of the invention revolutionises the concept of quality check in the production of security sheets and removes with a single blow all precision and accuracy constraints which used to negatively affect the known integrated systems within printing machines.

Incidentally, thanks to the fact that the inspection process is not tied to the throughput of the printing machine, a series of further advantages can be obtained.

The sheet moving system is conceived to present every individual sheet opposite the camera or the other sensors at an ideal speed for best possible image acquisition, not constrained by the process speed of the printing machine. The illumination system provides good quality light for the acquisition of colour images, without the constraint of having to generate such an amount of light as to allow an exposure time of a few microseconds, as is instead required for image acquisition at a translation speed of 3 m/sec typical of known inspection systems in line with the printing machine.

Transport speed and the time available allow to employ a single camera with more than 10,000 pixels per line, opposite which the sheet travels by means of an extremely accurate and stable movement system.

For each inspected sheet, about 600 Mb of data are acquired and processed: this is made possible by the fact that it has been possible to untie the acquisition process from the handling time imposed by the printing machine, which would have been of about ⅓ of a second for each sheet.

The measurement and inspection algorithms are defined with the aim of being accurate within an execution time which is quantifiable in a few seconds and not in milliseconds, as is instead the case for a traditional in-line inspection system.

However, it is understood that the invention is not limited to the particular configurations illustrated above, which represent only non-limiting examples of the scope of the invention, but that a number of variants are possible, all within the reach of a person skilled in the field, without departing from the scope of the invention.

For example, next to the sensors illustrated above, bar code reading devices can be provided within the apparatus for tracking and identifying the specific security sheets which are inspected.

1) An inspection apparatus for security sheets of the type comprising at least a main driving cylinder, on the outer surface of which a security sheet to be inspected is made to adhere, as well as an inspection system comprising at least an illuminator, a camera for sheet image acquisition and a processing unit of said image to check for sheet print quality, characterised in that a sheet feeder is further provided to feed sheets from a tray above the main cylinder, as well as a pair of secondary cylinders, mutually adjacent and adjacent to said main cylinder to pick up each security sheet from the main cylinder, upturn it and present it again turned face down on said main cylinder, the three cylinders being apt to rotate and being controllable independently from each other, the cylinders and the inspection system being housed in a self-contained unit.

2) The apparatus as in claim 1), wherein said main cylinder has calibration targets of the inspection system.

3) A printing machine comprising, inserted in one of its pile or test outlets, or in a purpose-designed outlet, an apparatus as in claim 1), security sheets being directed samplewise towards said outlet occupied by the inspection apparatus according to predetermined criteria.

4) The printing machine as in claim 3), wherein said predetermined criteria consist in a predetermined and adjustable time interval.

5) The printing machine as in claim 3), wherein said predetermined criteria consist in a control signal automatically sent to the printing machine by said inspection apparatus.

6) The printing machine as in claim 5), wherein said control signal sent to the printing machine is issued according to a statistical analysis of print quality detected by said apparatus on the security sheets.

7) A method for checking security sheet quality comprising the steps of completing a printing process and samplewise drawing a sheet, from a printing machine outlet, characterised in that it further comprises the steps of directing said sample sheet towards an independent inspection apparatus, located in a selectable outlet of said printing machine, performing a quality check with said apparatus on said sample sheet, to detect any print parameters which deviate from predetermined nominal values, according to said quality check, supplying information on adjustment parameters of the printing machine apt to restore the nominal conditions of said print parameters.

8) A method for checking security sheet quality comprising the steps of completing a printing process and samplewise drawing a sheet, from a printing machine outlet, characterised in that it further comprises the steps of directing said sample sheet towards an independent inspection apparatus, located in a selectable outlet of said printing machine, performing a quality check with said apparatus on said sample sheet, to detect any print parameters which deviate from predetermined nominal values, according to said quality check, supplying information on adjustment parameters of the printing machine apt to restore the nominal conditions of said print parameters, wherein said inspection apparatus is as in claim 1).

9) A control method for a security sheet printing machine, characterised by the steps of providing an independent high-definition inspection apparatus at an outlet of said printing machine, directing a sample security sheet towards said outlet where the independent inspection apparatus is installed, performing a full inspection cycle on said sample security sheet to check print quality thereof, determining whether there are print parameters which deviate from predetermined nominal values, in correspondence of said determination, sending a correction signal from said inspection apparatus to said printing machine to adjust operation thereof in the sense of bringing back said print parameter towards its nominal value.

10) A control method for a security sheet printing machine, characterised by the steps of providing an independent high-definition inspection apparatus at an outlet of said printing machine, directing a sample security sheet towards said outlet where the independent inspection apparatus is installed, performing a full inspection cycle on said sample security sheet to check print quality thereof, determining whether there are print parameters which deviate from predetermined nominal values, in correspondence of said determination, sending a correction signal from said inspection apparatus to said printing machine to adjust operation thereof in the sense of bringing back said print parameter towards its nominal value, wherein said independent inspection apparatus is as in claim 2).

11) A printing machine comprising, inserted in one of its pile or test outlets, or in a purpose-designed outlet, an apparatus as in claim 2), security sheets being directed samplewise towards said outlet occupied by the inspection apparatus according to predetermined criteria.

12) A method for checking security sheet quality comprising the steps of completing a printing process and samplewise drawing a sheet, from a printing machine outlet, characterised in that it further comprises the steps of directing said sample sheet towards an independent inspection apparatus, located in a selectable outlet of said printing machine, performing a quality check with said apparatus on said sample sheet, to detect any print parameters which deviate from predetermined nominal values, according to said quality check, supplying information on adjustment parameters of the printing machine apt to restore the nominal conditions of said print parameters, wherein said inspection apparatus is as in claim 2).
